(19) United States
(12) Patent Application Publication
(10) Pub. No.: US 2013/0316313 A1
(43) Pub. Date: Nov. 28, 2013

(54) Lifestyle Management System And Method

(71) Applicant: Adam Darrow, Owings Mills, MD (US)

(72) Inventor: Adam Darrow, Owings Mills, MD (US)

(21) Appl. No.: 13/903,794

(22) Filed: May 28, 2013

Related U.S. Application Data
(60) Provisional application No. 61/651,720, filed on May 25, 2012.

(51) Int. Cl. G09B 5/00; G09B 19/00

(52) U.S. Cl. CPC G09B 5/00; G09B 19/00
USPC 434/236

(57) ABSTRACT

An improved method for providing lifestyle management services over a network includes the steps of: (a) utilizing a server on the network to provide these services, wherein the server includes a processor, software and memory, (b) configuring this software to: (i) register one to be a user of these services, (ii) utilize an interactive calendar, an interactive lifestyle log, a balance displacement factor (BDF) or metric, a stress indicator percentage (SIP) or metric and (iii) yield a visual representation of a plot versus time of the values of the temporally varying BDF and SIP so as to provide feedback that advises on how to modify one's daily activities so as to better manage one's lifestyle to cope with the demands and stresses of daily life while yielding greater success in achieving one's life goals.

### CROSS-REFERENCE TO RELATED APPLICATION

This application claims the priority and benefits of U.S. Provisional Patent Application No. 61/651,720, filed May 25, 2012 by the present inventor and entitled the same as the current application. The teachings of this application are incorporated herein by reference to the extent that they do not conflict with the teaching herein.

### BACKGROUND OF THE INVENTION

1. Field of the Invention

The present invention generally relates to data processing systems and methods. Specifically, the invention relates to a system and method for lifestyle management.

2. Description of the Related Art

For millions of people, it feels like an uphill battle to fulfill their responsibilities from the moment they wake up till the moment they go to sleep. They suffer from oppressive daily stress, too little sleep/rest and diminishing hopes of achieving life goals. They would be encouraged by a product that serves as a stepping-stone to acquiring the necessary will and means to make meaningful, but often easier-said-than-done, changes in their lives. Users reflect on past decisions, identify recurring trade-offs and realize small steps that they can take, which represent real systemic long-term, lifestyle changes that are more in line with their goals. These actions accumulate and users find themselves in a better position (mentally, physically, financially, etc.) to succeed.

A great need exists for a lifestyle management system that is sophisticated enough to match the complexities of daily life. From global worries, such as the economy or terrorism, to more personal ones, such as family, overloaded schedules and work-related anxieties, there is an abundance of stress and complexity in today's world. There is a general consensus in the medical community that stress plays a major role in a person's lifelong health. The bottom line is that better organization equals lower stress, which equals less health problems and an increased ability to achieve life goals.

Low-tech organizational alternatives such as pen & paper (daily planning calendars, etc.) are much better than no organization at all, but it is very difficult to maintain and becomes unmanageable and messy over time.

The self-help industry is comprised of many niche markets (conventional and holistic healthcare, exercise, nutrition, relationships, motivational, financial, etc.). These services/tools are actually compliments to the present invention, not competition or alternatives per se. They typically call on their clients/subscribers to have the will to make significant sacrifices based on easier-said-than-done recommendations. They also leave clients/subscribers on their own to find the means (the time, the money, the energy) to follow recommendations, even if they are willing. If clients/subscribers express any kind of difficulty, they are often told “If this is really a priority for you, then you'll find a way”.

The current marketplace has many technology providers, including GPS, smart phone/mobile and voice recognition providers, who partner with various “self-help service providers” to capture new tasks/reminders, file/sort them and notify the user when to do them—the goal being to make users' lives easier. These technologies are presented front and center while the platforms that compliment the technology seem more of an afterthought (i.e. to-do list, shopping list, grocery list, appointments). Beyond what common organizational alternatives can offer, there seems to be a heavy reliance on the creativeness and savviness of their users to find specific real-life applications of the service that add real value.

There also exists “decision systems” which make decisions for users as to what to do and when. Most of these systems are based on Stephen Covey's “The Habits Of Highly Effective People” methodologies, which prioritizes tasks based on urgency and importance. With some systems, users are asked to assign urgent/important values to every task. Then the system proposes a schedule, concentrating on “not urgent, but important tasks”, as those are the ones that often fall through the cracks.

Attempting to get users to focus on “not urgent, but important tasks” by simply assigning those tasks higher priority on the to-do list is an overly simplistic solution to a complex problem. Discipline and focus on long-term achievements are certainly issues for many people, but how to integrate long-term tasks into a daily schedule while not completely giving up short-term pleasures and pastimes is a real challenge. In fact, the label of “not important” implies that one should try to focus only on “important” tasks.

A current provider in the stress management market, AboveStress®, asks users to rate their stress throughout the day. The present invention focuses on the two main indicators of stress—work level and sleep. So rather than asking users to rate their stress at any given moment, the present invention provides guidelines and asks users to rate their work and sleep levels one time each day and then calculates the users' stress indicator percentage (SIP).

Despite there being numerous products and service providers in the lifestyle management market, many people are still seeking something better. There is still a need for an improved method and/or product for lifestyle management.

### SUMMARY OF THE INVENTION

Recognizing the need for the development of an improved system and method for lifestyle management, the present invention is generally directed to overcoming the problems and disadvantages exhibited by existing, lifestyle management systems and methods. The objective is to create an end-to-end solution for managing life—from every day affairs to life goals to health treatments (conventional, holistic and self-help).

The present invention can take the form of a method for providing the service, in an environment of network having networked computing devices, of advising a service user on how to better manage the lifestyle and activities of a service user who is seeking to better cope with the demands and stresses of daily life while trying to achieve specified life goals. It includes the steps of: (a) utilizing a server on the network to provide these lifestyle management services, wherein the server includes a processor, software and memory, (b) configuring this software to: (i) register one to be a user of these services, including collecting and storing information that identifies the service user, (ii) utilize an interactive calendar configured to allow one to input and schedule at various times and for various durations throughout the day those activities of the service user that are involved in daily routine activities, sleep and rest, and the discretionary periods of time during which the discretionary tasks are undertaken, (iii) utilize an interactive goal log configured to allow the service user to input into this goal log and document the life goals of the service user, (iv) utilize an interactive lifestyle log configured to allow a service user to input and document the daily level of effort devoted to the work activities and the daily duration and quality of one's sleep, (v) utilize a balance displacement factor algorithm to compute a balance displacement factor that is configured to allow a system user to assess one's current activities in terms of the progress that the service user is making towards achieving life goals while maintaining a balanced lifestyle, (vi) utilize a stress indicator percentage algorithm to compute a stress indicator percentage configured to allow a system user to assess the current activities in terms of the progress that the service user is making towards achieving one's life goals while minimizing the periods of extreme stress in one's life, and (vii) yield a visual representation of a plot versus time of the values of the temporally varying, balance displacement factor and stress indicator percentage in such a manner that this plot provides feedback to the service user that is helpful in advising on how to modify one's daily activities so as to better manage the lifestyle and activities to better cope with the demands and stresses of daily life while yielding greater success in achieving specified life goals.

A variant of this preferred embodiment further includes the step of configuring the software to utilize an interactive stress log configured to allow one to input, document and assess the notable stresses that are encountered during one's day and to try to associate these stresses with those external factors that are perceived to be creating these stresses.

Another variant of this preferred embodiment further includes configuring the interactive calendar to: (i) allow a service user to input into the software feedback on the discretionary tasks and any significant deviations in the activities of the daily routine or planned periods of rest of the service user, and (ii) compute the sum of the duration of time spent by the service user during each of the periods devoted to daily routine, rest and discretionary tasks.

The present invention can also take the form of a system which can perform all of the steps of the above summarized methods.

Thus, there has been summarized above (rather broadly and understanding that there are other preferred embodiments which have not been summarized above) the present invention in order that the detailed description that follows may be better understood and appreciated.

### BRIEF DESCRIPTION OF THE DRAWINGS

FIG. 1 is a block diagram illustrating the general architecture and elements of the present invention.

FIG. 2 is an illustrative example of an interactive calendar of the type used by the present invention.

FIG. 3 is an illustrative example of a goal log of the type used by the present invention.

FIG. 4 is an illustrative example of a lifestyle log of the type used by the present invention.

FIG. 5 is an illustrative example of a stress log of the type used by the present invention.

Table 1 is an illustrative example of a graphical representation of an interactive calendar of the type used by the present invention and showing the allocation of the listed activities as either routine, sleep or other/discretionary.

Table 2 is a plot of daily BDF values versus time for the data shown in Table 1.

Table 3 is an illustrative example of the daily assessments that one would enter into one's interactive lifestyle log.

Table 4 shows SIP calculations for the data shown in Table 3 and assuming α₁ and α₂=1.

Table 5 is a plot of daily SIP values versus time for the data shown in Table 4.

### DESCRIPTION OF THE PREFERRED EMBODIMENT

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The present invention generally relates an improved method or system for improving one's lifestyle management. In a first preferred embodiment, it is an improved computerized system for managing the lifestyle or activities of one seeking to better cope with the demands of daily life while trying to achieve specified life goals.

The present invention is built on life goals as a prime motivator, with short-term goals and the ability to link specific tasks to short-term goals. An additional benefit of the present invention is that it allows users to better manage their daily activities so as to reduce their stress levels. An internet enabled embodiment of the present invention has 24/7 phone support, and is capable of including more complete consultation via specially-trained, registered nurses, health/life coaches, mentors and other holistic professionals.

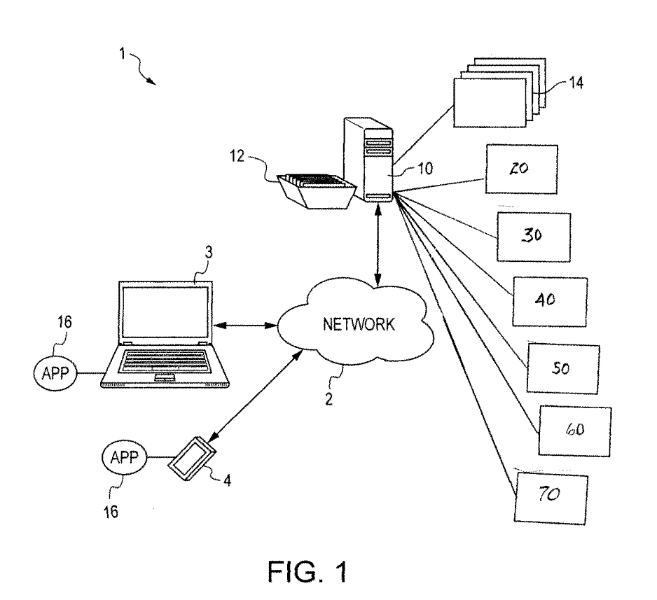

The architecture of the present invention 1 is described generally in connection with FIG. 1. A user of the present invention 1 connects to a network 2 (e.g., the Internet or other network connection) via a computer processing device such as a laptop 3, desktop PC, smart phone 4, etc. Also connected to this network is the server 10 that is used by the present invention. It is utilized by the present invention to provide a “life management” service whereby a user enters into an, e.g., subscription-type, agreement with the entity operating the present invention to provide this service to the user.

The server of the present invention also communicates with a database 12 that stores the information which users input into the various logs of the present invention. The control software that runs on this server is configured such that it allows a user to register for the services of the present invention and input information into its database. The software of the present invention organizes and analyzes this information in terms of the various metrics defined and used by the invention in order to provide feedback to system users regarding how to best manage their daily activities so as to lead a balanced lifestyle—thereby allowing them to have more success at achieving their designated life goals.

The software of the present invention is further configured to: (a) help manage a user's stress levels—i.e., a user is asked to create interactive calendar, lifestyle, and stress logs, along with a listing of the key life's goals which they would like to achieve, which are interactively used by the present invention to provide its intended service, (b) integrate with a wide range of computer processing devices and their various input and output mechanisms so as to provide for the use of state-of-the-art accessibility and ease of use, (c) notify users, through automated proactive alerts, when there stress levels are too high for an extended number of days and provides proactive instructions for changing their activities, etc. so as to remedy such conditions, (d) create the various webpages or documents 14 of the website, cloud-based service platform, mobile application, software service or similar communication means that is used to provided the services of the system, including any special software applications 16 that may be needed to run on the various computing devices (e.g., smart phones) used by the present invention.

A service user's required tasks in using the present invention are seen to be minimal: register (once), load or populate one's interactive calendar with his/her daily routine and “calendar list”’ activities and keep these updated. Additionally, the software of the present invention can be further configured to make a service user's updating even more easy and convenient by allowing much of the required data to be automatically entered by utilizing existing interfaces and any software which a user may already be using and where such scheduling data would be stored.

All user interfaces of the present invention, as currently configured, are preferably HTML5 browser based. The software of the present invention is configured so as to perform on Windows and Apple desktops using current browsers. Smartphone and tablet compatibility is also provided—Apple iOS, Android, and Windows 8 are fully supported. To better acquaint one with the software requirements of the present invention, shown in this application's FIGS. are various user interface screen illustrations which could be in a webpage or smart phone or tablet format.

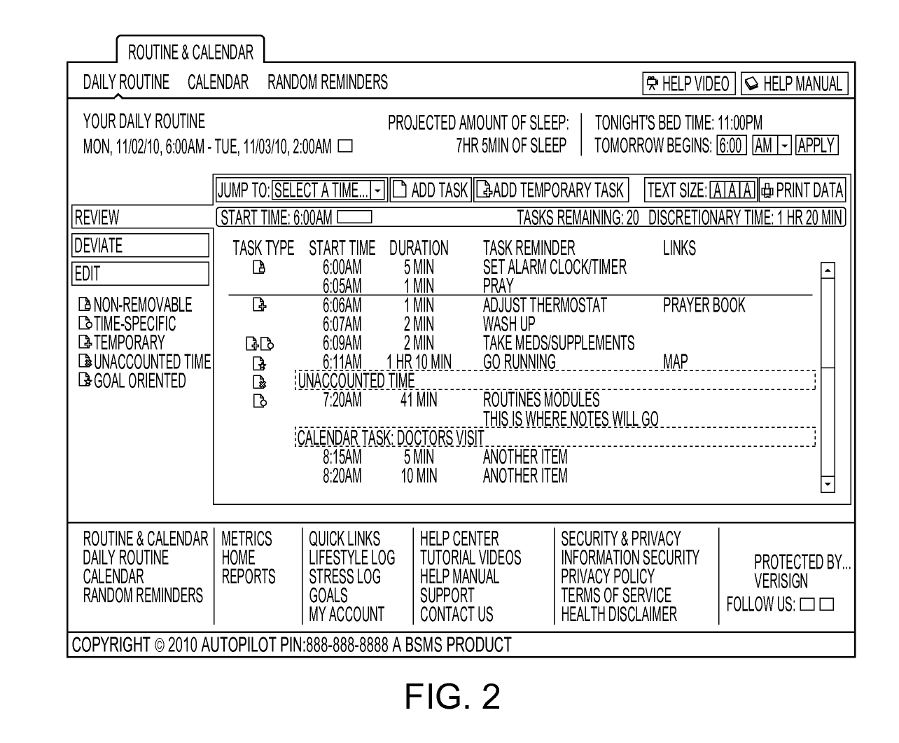

The present invention, in the form of an improved system for managing the lifestyle or activities of one seeking to better cope with the demands of daily life while trying to achieve specified life goals, includes an interactive calendar, 20. See FIG. 2. This calendar is created by software of the system to yield interactive screens or webpages on the graphical output screen of device which the user utilizes to access the system's server. Such webpages are configured to allow one to input and schedule at various times and for various durations throughout one's day, week, month or year those activities that are involved in: (a) one's daily routine, (b) the periods of time that one sets aside for sleep and rest, and (c) the other or discretionary periods of time during which one can elect to schedule discretionary tasks.

The configuration of this calendar 20 is also such that it allows one to provide input or feedback on discretionary tasks and any significant deviations in the activities of one's daily planned periods of rest. The software of the system is further configured so that it computes the sum of the time spent during each of the periods devoted to daily routine, rest and other or discretionary task and then calculates various metrics that are defined by the system and which serve to provide feedback to a system user on such matters as the user's progress towards stated goals, performance against “maintaining a balanced lifestyle,” and one's minimization of the amounts of stress that he/she is placing upon him/herself.

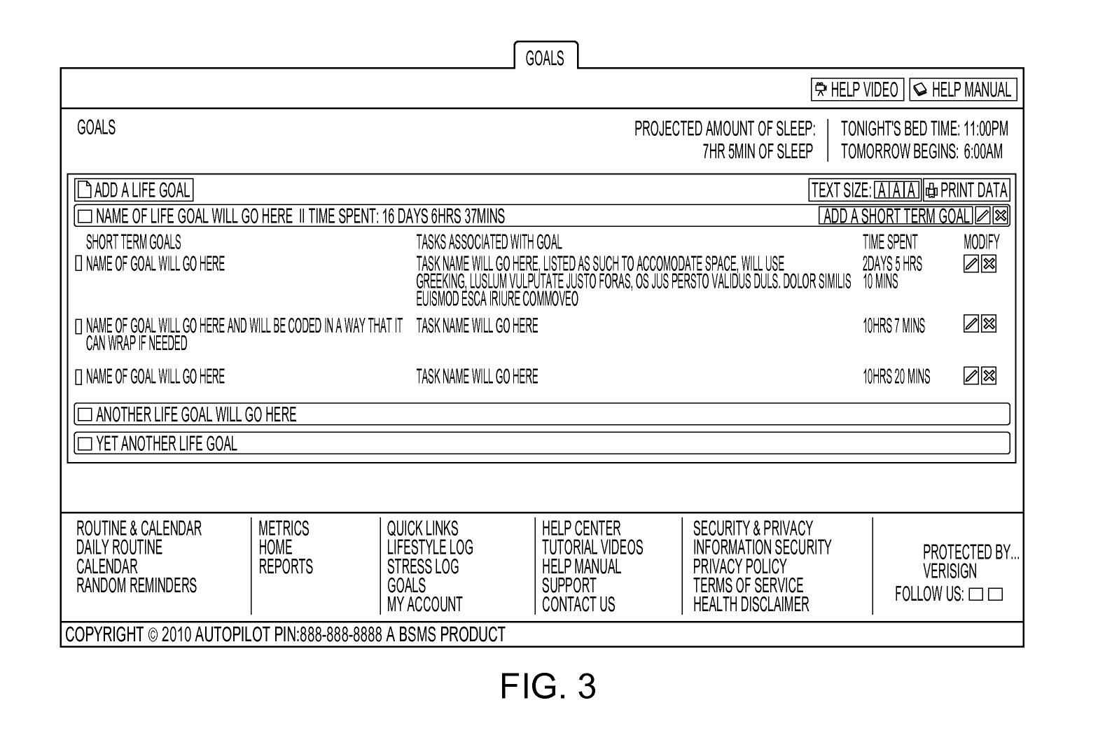

The present invention also includes an interactive goal log 30. See FIG. 3. This goal log is also created by the invention's software and displayed on interactive screens that are configured to allow one to decide upon and document one's life goals and to identify and list the discretionary tasks that one needs to complete in order to make progress towards achieving such life goals. They can then be displayed and listed on the interactive calendar so as to aid one in planning for the use of one's discretionary periods of time.

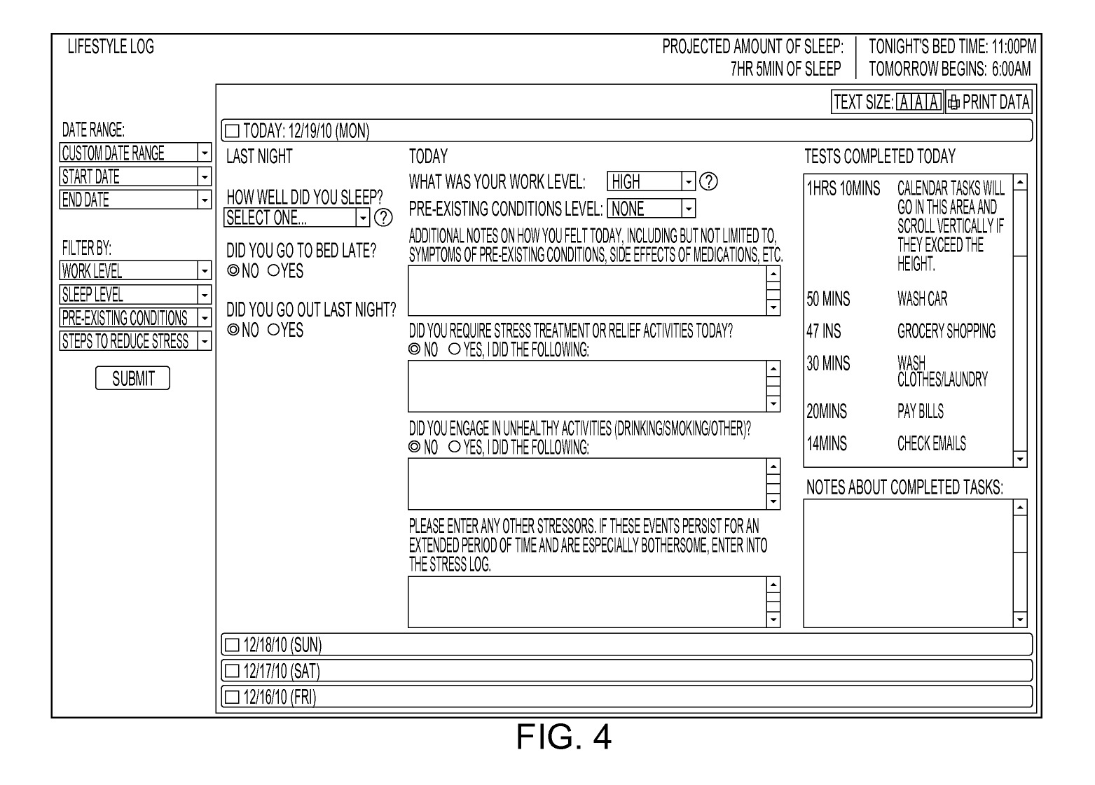

Also included in the present invention is an interactive lifestyle log 40 that is created by the system's software and displayed on interactive screens that are configured to allow one to input, document and assess health-related, life-style matters that are encountered during one's day and which impact one's temporally varying general level of wellness or health, including the daily level of effort devoted to one's work, the daily duration and quality of one's sleep, and other possibly healthy and unhealthy activities engaged in during one's day. See FIG. 4.

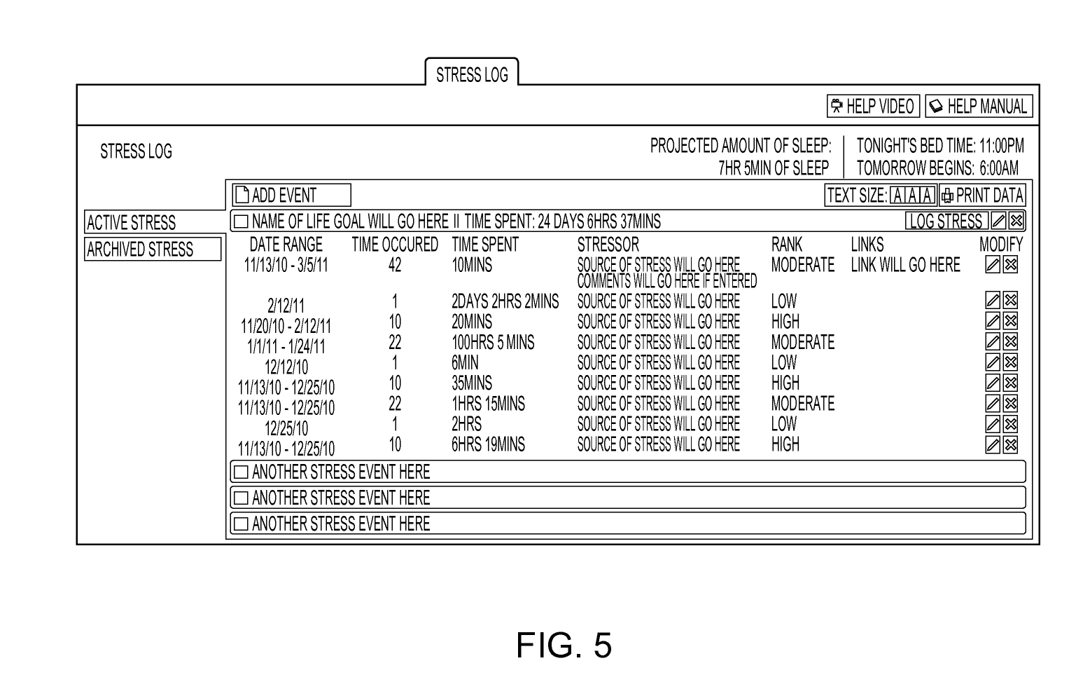

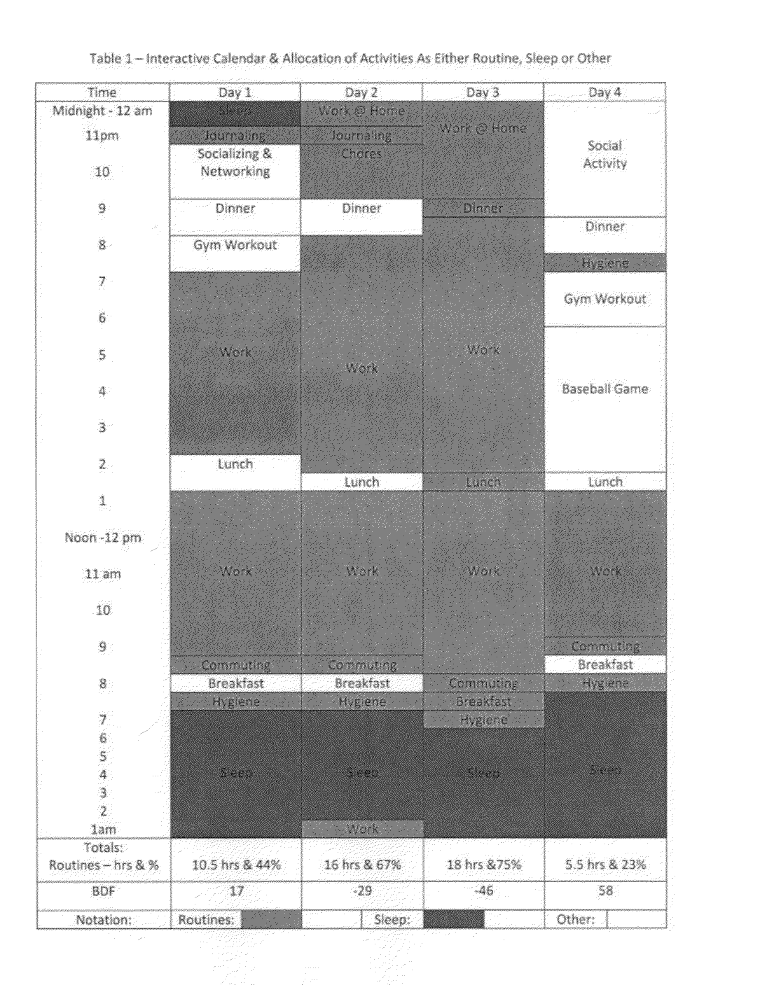

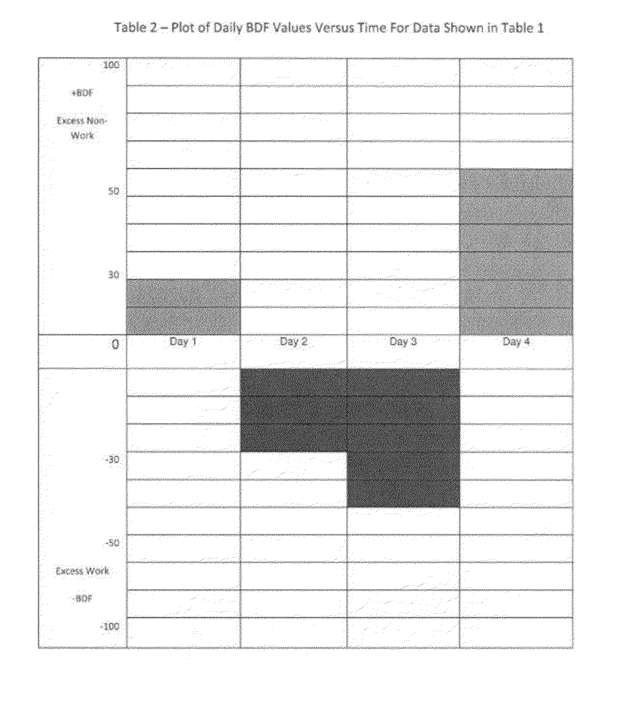

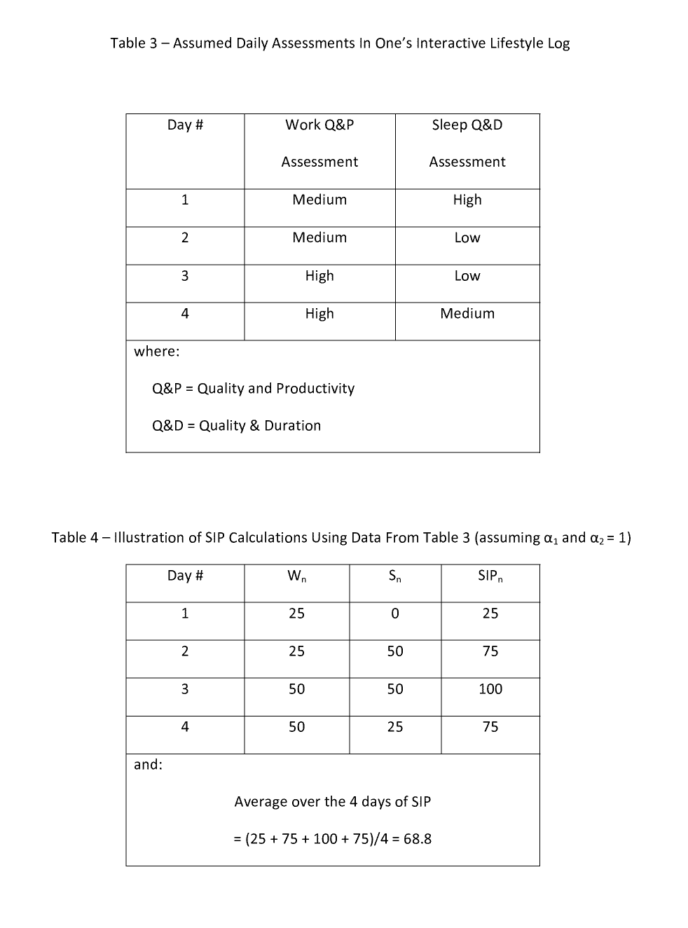

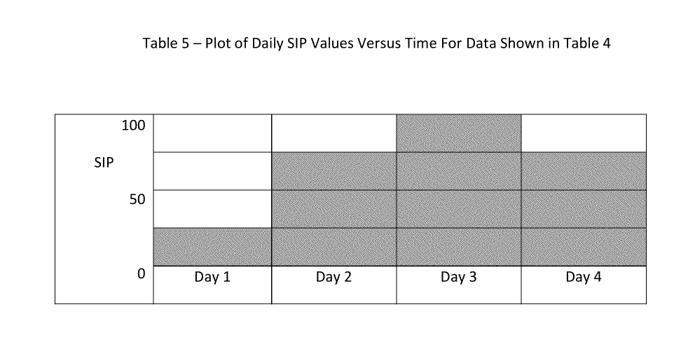

Related to such health-related and lifestyle matters is an interactive stress log 50 that is also a part of the present invention. See FIG. 5. As with the other parts, it is created by the invention's software and displayed on the invention's various, interactive screens which have a configuration adapted to allow one to input, document and assess the notable stresses that are encountered during one's day and to try to associate these stresses with those external factors that are perceived to be creating these stresses.

It was previously mentioned that the present invention defines and calculates various metrics that serve to provide feedback to a system user on such matters as the user's progress towards stated goals, performance against “maintaining a balanced lifestyle,” and one's minimization of the amounts of stress that he/she is placing upon him/herself. One of the principals upon which the present invention is based is that a balanced lifestyle maximizes a person's chances of achieving life goals and yields the most satisfaction in life. Conversely, an unbalanced lifestyle undermines the ability to perform both mentally and physically, which jeopardizes success.

Two key metrics that help users gauge their current lifestyles and measure/track progress toward achieving/maintaining a balanced lifestyle are the Balance Displacement Factor (BDF) 60 and Stress Indicator Percentage (SIP) 70, respectively.

The BDF is a gauge of how far away from “balanced” one's lifestyle is on a typical day. It represents a baseline from which one can begin understanding, generally, how much time and effort (even money from an indirect point of view) will be necessary to transition from one's current lifestyle to a “more balanced” or “balanced” one. Your BDF also serves as a tangible means of tracking such a transition, as one's BDF changes over time to reflect improvements that one makes to his/her lifestyle. The software of the present invention plots BDF versus time on one of the invention's may interactive screens that are used to track, report on system metrics and thereby provide feedback and guidance for a user.

Many possible algorithms exist for computing this BDF metric. All of them have a configuration adapted to allow a system user to assess one's current activities in terms of one's progress towards achieving one's life goals while maintaining a balanced lifestyle. Such algorithms are a function of the difference between one's measured, daily total time spent on daily routine, rest and other or discretionary activities and the comparable ideal times spent on each of these activities by one generally accepted to be leading a balanced lifestyle.

A preferred embodiment for a BDF algorithm is that BDF is related to approximately twice the difference between: 1) The average time allocated for work, sleep and other activities on which users indicate they spend their time, and 2) The targeted time allocation system default values that are generally accepted as representing a balanced lifestyle. In general, BDF equals approximately two hundred times the daily percentage difference between the temporal duration of a day that one spends on routine activities (the largest component of which is the compensated work that one performs to earn a living) and the temporal duration of a day that one spends on sum of sleep and other activities, and wherein an assumed, ideal balanced lifestyle has the percentage distributions of: Routines, R/W=52.0% (12.48 hours), Sleep, S=35.5% (8.52 hours—includes ½ hour to account for falling asleep initially and waking up in the middle of the night and falling back to sleep) and Others, 0=12.5% (3.0 hours—including cooking, eating, commuting, etc., and depending on the user's prevalent frame of mind):

BDF=200×[52%−(% of Time Spent On Routine Activities (e.g., work) in typical day)]

and, wherein:

(a) the range of BDF is seen to be −96 to +104, where for an unbalanced day spent all on Routine/Work (100% spent on Routine/Work), BDF=200×[52%−100%]=−96, and for an unbalanced day spent all on Sleep & Other (0% spent on Routine/Work), BDF=200×[52%−0%]=104;

(b) for an ideally balanced day, with R/W=52%, S=35.5% and O=12.5%, BDF=200×[52%−52%]=0,

(c) one should note that the above definition of BDF is based on a typical day rather than just any day on one's calendar—the difference is that the typical day would not be expect to change much from day to day. However, in situations where one is trying to identify the causes for a period or few days of especially high stress, it is useful to define BDF in terms of the time that was spent on routine activities for each of the actual days of the high stress period—in such situations we identify such a metric as a “daily BDF,”

(d) if there are off-day in the assessment period, adjustments would be prorated (e.g., if a user was off two days, then one's BDF calculation or determination would be multiplied by 5/7 to indicate that the individual only work five days a week and another BDF calculation for off days would be multiplied by 2/7, and then the two added together to one's get final BDF).

One's allocation of their time as “routine” or “other” activities is thus seen to be a key aspect of the present invention—assuming that system users will have little or no difficulty in identifying the hours they spend on the activity of “sleep.” The system attempts to provide clear guidelines as to how this allocation is to be handled.
One's “routine or daily routine” is defined simply as how one spends his/her time on routine tasks during a typical work/school day—i.e., if you perform a task every day and rarely skip it, then it's a daily routine task. In addition to specific routine tasks associated with one's work/school, there are usually two (maybe three) similar time periods throughout the day that one typically devote to non-daily tasks that one performs so often in such a manner that they also become similarly “routine. For example, let's say you usually do housework for an hour when you get home from work/school. Depending on when things are due, you may pay bills, clean the bathroom, do laundry or work on a home project. Although the tasks are different each day, the general time period in which you do them is consistent. In the present invention or system, these time periods are defined as “calendar list periods” and the task themselves are known as calendar tasks. In terms of an allocation as either “routine” or “other,” such “calendar list periods” will often be allocated as “routine” activities depending upon the system user's frame of mind when performing them.

For example, cooking infrequently would be described as an activity that undertaken in a “calendar list period” and as a calendar list task—but, its allocation would be a function of the performer's frame of mind—if one, while performing this task finds it to be recreational and possibly stress relieving, it would be allocated as an “other” activity. Meanwhile, if one found this cooking it to be a chore, he or she would allocate this period on one's daily calendar log as a “routine” activity—as such, this period of time would be used in the above calculation of BDF.

A new system user starts to set-up his/her account with the present invention by completing a screen or webpage of inquires generated by the software of the present invention in order to indicate what his/her own “daily routine” or “routine” is. This is usually done by adding daily routine and calendar list tasks to one's interactive calendar.

To illustrate the use of this equation for calculating “daily BDF,” assume that a system user has recorded in her interactive calendar log the daily activities shown in Table 1. Also shown in this table by shading is the allocation of the various day's activities into one of the three system defined allocations of routines, sleep and other. For these logged daily activities and after allocating them, one can compute the hours spent on each of the given days doing routine/work activities and the consequent percentage (%) of the hours in a day spent on routine activities. It is this parameter that is used in the above equation to calculate the day's BDF. These calculations are shown near the bottom of Table 1.

To better comprehend the temporal variations in relative balance that one exhibits in his/her daily activities, it's helpful to plot “daily BDF” values shown in Table 1 versus time as a step function, see Table 2.

The system's Stress Indicator Percentage (SIP) 70 is defined to be a combined measurement of two of the most informative indicators of stress—work level (quantity) and sleep level (quality and quantity). SIP is the weighted average over a defined span of time of the number of instances of low, medium and high for work level and sleep level as indicated and inputted into the system by a user on a daily basis, the user's judgment of which is based on certain guidelines provided by the system.

The quantity of work level is considered to be more controllable by users than the quality of sleep (which could be affected by many factors other than those under a user's control). Similarly, the treatments or remedies for being overworked are considered more available and immediate than treatments for difficult sleep issues. Since SIP is designed to trigger action from users when it rises to an unsafe level, it makes more sense to trigger that action when users generally have more control (e.g., reduce workload or get treatment for stress). Therefore, work level is often weighted slightly more than sleep.

It can be argued that sleep (or lack thereof) is actually the best predictor as it relates to stress-triggered health issues. However, high work level is usually the cause of a low sleep level, so from a prevention standpoint, the root cause of symptoms of stress is work-related scheduling decisions, and therefore the present invention weights work slightly more than sleep in the SIP calculation.

A preferred embodiment for a SIP algorithm can also be defined such that it has a configuration adapted to guide or allow a system user to assess one's current activities in terms of one's the levels of stress that these activities are placing on the individual. It is a function of one's daily stresses as measured by the resulting duration and quality of sleep and the effort levels that one is able to devote to one's work during a given day. An illustration of a typical algorithm for computing one's SIP is given below:

SIP=work SIP+sleep SIP

SIP=(α₁ΣWₙ+α₂ΣSₙ)×1/N

where:

Wₙ is the user's assessment of his/her work level on the nth day in a string of N days over which the average SIP is to be calculated, and where the assessment rankings & imputed parameters into the equation are:

Low work level=0

Medium work level=25

High work level=50

Sₙ is the user's assessment of his/her sleep quality level and duration on the nth day in a string of N days over which the average SIP is to be calculated, and where the assessment rankings & imputed parameters into the equation are:

Low level of combined sleep quality and duration=50

Medium level of combined sleep quality and duration=25

High level of combined sleep quality and duration=0

α₁ and α₂ are assigned weighting factor for the respective work and sleep parts of the equation, and

Σ is defined as the mathematical symbol that informs one to perform the function of summing over a series of N members of W's: W₁, W₂, W₃, . . . , Wₙ

To illustrate the use of this equation for calculating SIP on a daily basis, assume that a system user has recorded in her interactive lifestyle log the daily assessments shown in Table 3. In terms of calculating SIP, this information yields (assuming α₁ and α₂=1) the values shown in Table 4.

To better comprehend the temporal variations in one's stress levels, it's helpful to plot them versus time as a step function such as that shown in Table 5.

A key point of usefulness of the present invention is that the visual graphics of the system are configured in such a way as to help a user to identify which of his/her activities may be the cause of any excess stresses that the user might be suffering and one's inability to make satisfactory progress towards meeting espoused and logged life goals. For example, with the illustrative visual graphics in Table 1, it is possible for a system user to possibly identify what activities on those days might have been responsible for the high levels of stress that are indicated by the comparatively high levels of SIP indicated on the second through fourth days as indicated in the above table.

It should also be noted in the plot or table above of daily BDF values that the second and third days are also those days on which the user's calculated, daily BDF metric was at values that were furthest away from a zero value and therefore a balanced lifestyle. Examination of the user's interactive calendar can give more feedback as to the possible reasons for the excessive stresses or inability to make progress towards one's goals. Additionally, a user's daily stress log can also be helpful in identifying the underlying causes of such excessive stresses.

In using this SIP metric, it is also helpful to define a “SIP threshold”—the point of a user becoming symptomatic because of having incurred excessive stresses for a period of time. By plotting the SIP levels with the self-reporting symptoms of stress-related health issues, the user can identify the general range at which he/she becomes symptomatic. Then, to the extent that users can manage their activity levels to stay below this SIP threshold, they will reduce the frequency and severity of symptoms, not to mention be more productive and focused on goals because they won't be preoccupied with health problems. The design of the software makes it easy to stay aware of what your stress levels are running by having the SIP value at the top over every webpage that is presented to a user. This way, no matter what you are doing in the system, you can simply glance up and know your current SIP level. One's projected amount of sleep is also prominently displayed on every webpage for the same reason, since sleep deprivation is a big issue in our society today, and a main factor in creating excessive stress levels.

The system also provides the ability for a user to set their thresholds for stress and turn on what is called a “recovery mode”. This is a feature that automatically gets triggered when users approach their thresholds—displaying a notification of the urgency in addressing their stress (reducing/minimizing and possibly relieving/treating) to prevent health issues from arising or getting worse. Users are also be reminded that, in their weakened state, they are not able to perform to the best of their ability and therefore are less likely to achieve their life goals. The system will make certain common-sense recommendations. This feature can be switched on/off. It is set to off by default, because one needs to have amassed enough data to make the SIP threshold reliable.

The system can also tie-in automatic notifications when a user is in “recovery mode,” since this is a time when, for whatever reason, users cannot control as well their activity levels as they approach their SIP threshold and need help coping. A healthcare professional can be automatically notified of this increased risk, so that appropriate measures can be taken. For example, doctors may want to temporarily increase the dosage of a maintenance medication if this situation arises and circumstances call for it. Another example would be notifying an acupuncturist or massage therapist of their choice (the system can pre-authorized such notifications) so that they could book an appointment ASAP for some stress-relieving treatment.

The present invention connects a users' health to their scheduling decisions—allowing users to quickly and accurately consider how their stress levels have been running, how much sleep they've been getting, etc.

Every task that is logged into or set up in the system can have virtually an unlimited number of links associated with it—links to web pages, files on users' personal computers or uploaded files (for remote access) including pictures, videos, spreadsheets, text files, etc.

The present invention allows users to post personal thoughts in the lifestyle and stress logs much like they would post less personal thoughts on Facebook® and Twitter®. The present invention also compiles a short list of pre-selected tasks (candidates for final consideration on any given day) along with tasks that are due or overdue—making up the current day's Short List. This pre-selection and compilation process allows users to pre-select from which friends and interests that they want to see active posts.

The present invention's requirement for a user to log his/her activities, provides the system with a behavioral reporting component. The present invention can be used to identify the trade-offs that users tend to make when deviating from their schedules. It shows other interesting and helpful facts as well such as trends in users' stress levels and correlations between that and aspects of the user's health. It's this type of tangible and objective information that is the cornerstone of the system's effectiveness at motivating users to change their behaviors and lifestyles, and it is what sets, the present invention apart from other self-help tools (i.e., the system's aides to the process of self-realization and personal accountability).

The present invention squarely focuses a user on his/her chronic stresses and periods of sleep deprivation—two of the biggest problems people face in our post-modern world. It serves as a comprehensive, holistic solution by focusing on the whole person for the single purpose of providing peace of mind to a user that he/she is on the best path to happiness and success.

The present invention's behavioral reporting component allows a user to identify the trade-offs that users tend to make when deviating from their schedules—i.e., it serves as a trade-off analyzer. It allows one to find correlations between certain stress levels and when users become symptomatic with regard to a specific stress-triggered health issue.

Key features of the present invention include:
1) 24-hour time management/reminder system,
2) Provides a tool for life management,
3) Introduction of stress management tools and method,
4) Requirement for user input and journaling,
5) Visual graphics that report on how users spend their time—by using charts, graphs, etc.
6) A holistic solutions that seeks to provide users with the necessary will and means to make meaningful, but often easier-said-than-done, changes in their lives.

In the daily decision-making process of creating a personal schedule, the present invention switches users' perspectives from one of first establishing what responsibilities they have to others and filling in the rest of their time for themselves to a more self-centered approach of first establishing their own personal needs, followed by their responsibilities to others. The emphasis on one's own needs and wants is what drives motivation. It's therapeutic as well in so far as giving users more of a sense of control over their lives.

Inevitably, the time required for a day job, school and responsibilities to others usually bleeds over into personal time, creating chronic stress and a vicious cycle of dealing with issues resulting from that stress, which undermines one's ability to succeed, which, in turn, creates more stress. The present invention measures this imbalance and provides a tangible target/goal for restoring balance. It also provides an organizational structure that is designed to immediately reduce sources of daily stress.

The present invention also has a personal accountability aspect to it in which users reflect on past decisions, identify recurring trade-offs, and realize small steps that they can take, which represent real systemic long-term lifestyle changes that are more in line with their goals. These actions accumulate and users find themselves in a better position (mentally, physically, financially, etc.) to succeed.

Focusing on stress management, system users maximize their chances of successfully addressing the other preventable risk factors for poor health (sleep deprivation, lack of exercise, nutrition deficiency, etc.), which, in turn, will improve productivity and maximize the chances of achieving life goals.

The system's time management/reminder portions are configured to effectively reduce daily stress by organizing workflows into modules (templates), each designed for minimal system maintenance and minimal effort to use in making informed decisions; thereby significantly reducing the burden/labor that is usually associated with tracking daily activities.

The present invention's personal accountability aspect focuses on life goals—Users document their current lifestyles in a way that all activities/tasks are organized and linked (directly or indirectly) to life goals. Users can identify and realize trade-offs that they make (consciously or not) and make better choices about daily activities.

Its personal project management aspects are easy to implement: (a) create a plan—Users' current lifestyles serve as a baseline, but change over time to be more in line with life goals. The system uses its BDF metric to show how balanced a users' daily routines is, (b) adhere to the plan—its reminder/time management component accounts for every task, so users can be well informed as to their progress at any given moment—in addition, there is a group of tasks users designate as relatively discretionary in nature, in which they predetermine the relative importance and most convenient or efficient time of day to accomplish each task, allowing them to be very selective when making on-the-fly decisions in an effort to adhere to the plan, and (c) measure and analyze results—using health/lifestyle data (entered daily by users), the system measures and displays daily stress levels and the degree to which a user's activities are relatively balanced—users thereby get a more tangible and objective view of the causes of their stress—users can make informed lifestyle decisions based on this information.

Users are helped by the system to focus on discretionary tasks when making scheduling decisions by: (a) compiling a short list each day of pre-selected tasks for final consideration—this way, users can quickly and easily finalize their commitments, (b) automatically smoothing out users' schedules based on a set of priority parameters, (c) utilizing “importance bubbles (graphical ranking of 0 to 5 bubbles)” to further refine users' pre-determined commitment level (especially helpful when making quick on-the-fly decisions), and (d) determining cost/benefit of users' decisions in the context of projecting their impact on one's amount of sleep and instantaneously notifying users if they deviate from their plans in reaction to some unforeseen event or to seize some unexpected opportunity.

The present invention is based on the premise that motivation resides within each individual in the form of needs/wants. The expectation is, as the personal accountability aspect of the present invention takes hold, users will realize small steps that they can take, which represent real systemic long-term lifestyle changes that are more in line with their goals. These actions accumulate and users find themselves in a better position (mentally, physically, financially, etc.) to succeed.

Other optional features of the present invention include:

1) In the initial set up/registration screen, two options exist for pre-populating the daily routine and calendar logs: “general” and “customized”—making the process quicker, easier, more comprehensive and relevant to the user. Specialized information that could be used to customize include: (a) Miscellaneous lifestyle types, (b) Templates for disease management, (c) Local events (based on zip code), (d) Societal roles (parent, homeowner, day/night job, student, etc.), (e) Hobbies & special interests (schedules of local organizations or chapters of national organizations, associations, government activities), (f) Common holidays (national, religious, major/minor), and (g) Other notable dates such as daylight savings time and tax return due date.

2) In an “Add-A-Task” interface screen for the system's calendar, the user is asked if this task takes enough effort/time such that planning/preparation is needed and therefore warrants an alert (advance notification) being set up. If the answer is yes, then the user choose a number of days in advance for such an alert.

3) To the extent possible, integrate/interface/sync the calendar module/log screens with popular third party calendar products/services (Facebook, iCal/iCalendar, iCloud, Google calendar, Microsoft Outlook, BlackBerry, Evite, etc.) and provide phone lists, friends lists, etc.

4) Providing templates/screens that aid in creating life goals (complete with short-term goals and individual tasks). The purpose of this feature is to cut down on the amount of research time for a user to actually assemble viable plans for achieving his/her goals and thereby give the user a head start.

5) As part of the process of adding a task to go out shopping/eating, the software for the system is configured to allow a user pick to from a list of popular stores/restaurants they frequent. The list of places is based on users' zip codes and business hours, contact information, special deals, etc. can all be pre-populated in the tasks' notes field.

6) The software for the system is configured, for Interactivity/Intuitiveness, to help spread the word by, for example: (a) having a Facebook/Twitter post triggered by some event like “<user> achieved <goal>,” and (b) allowing non-customers to still use the more simple parts of the system that don't require a lot of setup effort (like the Lifestyle Log, which could calculate SIP).

7) Adding a schedule regulator (for Calendar Tasks) capability to the system by, for example: (a) adding two questions to the Add-A-Task interface: i. “In order to smooth out your schedule, how many days in advance are you willing/able to do this task?” and ii. “In order to smooth out your schedule, how many days are you willing/able to delay this task (up to and including skipping a whole cycle)?”—for time-specific tasks, the answers would default to -0- days; (b) adding preferred time ranges for non time-specific tasks, which will further refine how well system makes recommendations; and (c) configuring the software of the system to assist smoothing out one's schedule, i.e., it provides for the ability to analyze all possible combinations of tasks and picks the one that yields the shortest average workload per day (highest average amount of sleep per day),

8) Configuring the software of the system so that it has “trade-off analyzing” capabilities, i.e., the system discovers and reports back to the user any strong correlations between Daily Routine deviations in the form of periodic messages on the user's homepage. The system could also report the prevalence of combinations of tasks that are often deviated from on the same days and suggesting that the user tend to make these specific trade-offs;

9) Allowing users to enter their own frequency thresholds for the four types of deviations: temporary time adjustment, skip, move and wake-up time (tomorrow).

10) Providing the system with the ability for users to add customized fields in the Lifestyle Log for certain aspects of their lives that they often keep track (e.g., common symptoms or preferable stress treatments).

11) Providing the system with “speech-to-text” interfacing capabilities for use with smart phones,

12) Providing push/stream relevant health content information to users from third parties, based on customized fields in the Lifestyle Log, e.g., offering a variety of choices for news sources as well as for which aspects of their lives users want to get posts—this way users can keep abreast on the issues, research and latest developments on the issues that affect them the most,

13) Providing conventional medical & holistic advice support to users via email/chat/phone 24-7-365,

14) Configuring the system's software so that healthcare providers can join a users' network with standardized profiles, including: category, subspecialty, introduction video, written bio with picture, policies/procedures/office hours/emergency number, videos, pictures, links, etc., and

15) Allowing users to make routine appointments online with participating healthcare providers.

It should be noted that the foregoing is considered as illustrative only of the principles of the present invention. Further, since numerous modifications and changes will readily occur to those skilled in the art, it is not desired to limit the invention to the exact construction and operation shown and described herein. Accordingly, all suitable modifications and equivalents may be resorted to, falling within the scope of the invention that are hereafter set forth in the claims to the invention.

I claim:

1. A method for providing the service, in an environment of network having networked computing devices, of advising a service user on how to better manage the lifestyle and activities of said service user who is seeking to better cope with the demands and stresses of daily life while trying to achieve specified life goals, said method comprising the steps of:
utilizing said server on said network to provide said lifestyle management services, wherein server includes a processor, software and memory,
configuring said software to register one to be a user of said services, including collecting and storing information that identifies said service user,
configuring said software to utilize an interactive calendar having a configuration adapted to allow one to input and schedule at various times and for various durations throughout the day of said service user those activities that are involved in the daily routine of said service user, the periods of time that said service user sets aside for sleep and rest, and the discretionary periods of time during which said service user can elect to schedule discretionary tasks,
configuring said software to utilize an interactive goal log having a configuration adapted to allow said service user to input into said goal log and document the life goals of said service user,
configuring said software to utilize an interactive lifestyle log having a configuration adapted to allow one to input and document the daily level of effort devoted to the work activities of said service user and the daily duration and quality of one's sleep,
configuring said software to utilize a balance displacement factor algorithm to compute a balance displacement factor that has a configuration adapted to allow a system user to assess the current activities of said service user in terms of the progress that said service user is making towards achieving said life goals while maintaining a balanced lifestyle,
configuring said software to utilize a stress indicator percentage algorithm to compute a stress indicator percentage that has a configuration adapted to allow a system user to assess the current activities of said service user in terms of the progress that said service user is making towards achieving said life goals while minimizing periods of extreme stress in the life of said service user, and
configuring said software to yield a visual representation of a plot versus time of the values of said temporally varying, balance displacement factor and stress indicator percentage in such a manner that said plot provides feedback for managing the lifestyle and activities of said service user to cope with the demands and stresses of daily life while yielding greater success in achieving said specified life goals.

2. The method as recited in claim 1, further comprising the step of:
configuring said software to utilize an interactive stress log having a configuration adapted to allow one to input, document and assess the notable stresses that are encountered during one's day and to try to associate these stresses with those external factors that are perceived to be creating these stresses.

3. The method as recited in claim 1, wherein said configuration of said interactive calendar further adapted so as to allow said service user to input into said software feedback on said discretionary tasks and any significant deviations in the activities of the daily routine or planned periods of rest of said service user, and to compute the sum of the duration of time spent during each of said periods devoted to daily routine, rest and discretionary task by said service user.

4. The method as recited in claim 2, wherein said configuration of said interactive calendar further adapted so as to allow said service user to input into said software feedback on said discretionary tasks and any significant deviations in the activities of the daily routine or planned periods of rest of said service user, and to compute the sum of the duration of time spent during each of said periods devoted to daily routine, rest and discretionary task by said service user.

5. The method as recited in claim 1, wherein said configuration of said interactive lifestyle log further adapted so as to allow said service user to input and document the health-related matters encountered during the day of said service user that impact the temporally varying general level of wellness and health of said service user.

6. The method as recited in claim 2, wherein said configuration of said interactive lifestyle log further adapted so as to allow said service user to input and document the health-related matters encountered during the day of said service user that impact the temporally varying general level of wellness and health of said service user.

7. The method as recited in claim 1, wherein said configuration of said balance displacement factor algorithm further adapted so as to be a function of the difference between the measured, daily total time spent on the daily routine activities of said service user and the comparable ideal duration spent on said activities by one generally accepted to be leading a balanced lifestyle.

8. The method as recited in claim 2, wherein said configuration of said balance displacement factor algorithm further adapted so as to be a function of the difference between the measured, daily total time spent on the daily routine activities of said service user and the comparable ideal duration spent on said activities by one generally accepted to be leading a balanced lifestyle.

9. The method as recited in claim 1, wherein said configuration of said stress indicator percentage algorithm further adapted so as to be a function of the duration and quality of the sleep of said service user and the level of effort devoted to and the resulting productivity of the work of said service user.

10. The method as recited in claim 2, wherein said configuration of said stress indicator percentage algorithm further adapted so as to be a function of the duration and quality of the sleep of said service user and the level of effort devoted to and the resulting productivity of the work of said service user.

11. A system for providing the service, in an environment of a network of networked computing devices, of advising a service user on how to manage the lifestyle and activities of said service user who is seeking to better cope with the demands and stresses of daily life while trying to achieve specified life goals, said system comprising:
a server on said network that includes a processor, software and memory,
wherein said software having a configuration adapted to:
register one to be a user of said services, including collecting and storing information that identifies said service user,
utilize an interactive calendar having a configuration adapted to allow one to input and schedule at various times and for various durations throughout the day of said service user those activities that are involved in the daily routine of said service user, the periods of time that said service user sets aside for sleep and rest, and the discretionary periods of time during which said service user can elect to schedule discretionary tasks,
utilize an interactive goal log having a configuration adapted to allow said service user to input into said goal log and document the life goals of said service user,
utilize an interactive lifestyle log having a configuration adapted to allow one to input and document the daily level of effort devoted to the work activities of said service user and the daily duration and quality of one's sleep,
utilize a balance displacement factor algorithm to compute a balance displacement factor that has a configuration adapted to allow a system user to assess the current activities of said service user in terms of the progress that said service user is making towards achieving said life goals while maintaining a balanced lifestyle,
utilize a stress indicator percentage algorithm to compute a stress indicator percentage that has a configuration adapted to allow a system user to assess the current activities of said service user in terms of the progress that said service user is making towards achieving said life goals while minimizing periods of extreme stress in the life of said service user, and
yield a visual representation of a plot versus time of the values of said temporally varying, balance displacement factor and stress indicator percentage in such a manner that said plot provides feedback for managing the lifestyle and activities of said service user to cope with the demands and stresses of daily life while yielding greater success in achieving said specified life goals.

12. The system as recited in claim 11, wherein the configuration of said software further adapted to utilize an interactive stress log having a configuration adapted to allow one to input, document and assess the notable stresses that are encountered during one's day and to try to associate these stresses with those external factors that are perceived to be creating these stresses.

13. The system as recited in claim 11, wherein said configuration of said interactive calendar further adapted so as to allow said service user to input into said software feedback on said discretionary tasks and any significant deviations in the activities of the daily routine or planned periods of rest of said service user, and to compute the sum of the duration of time spent during each of said periods devoted to daily routine, rest and discretionary task by said service user.

14. The system as recited in claim 12, wherein said configuration of said interactive calendar further adapted so as to allow said service user to input into said software feedback on said discretionary tasks and any significant deviations in the activities of the daily routine or planned periods of rest of said service user, and to compute the sum of the duration of time spent during each of said periods devoted to daily routine, rest and discretionary task by said service user.

15. The system as recited in claim 11, wherein said configuration of said interactive lifestyle log further adapted so as to allow said service user to input and document the health-related matters encountered during the day of said service user that impact the temporally varying general level of wellness and health of said service user.

16. The system as recited in claim 12, wherein said configuration of said interactive lifestyle log further adapted so as to allow said service user to input and document the health-related matters encountered during the day of said service user that impact the temporally varying general level of wellness and health of said service user.

17. The system as recited in claim 11, wherein said configuration of said balance displacement factor algorithm further adapted so as to be a function of the difference between the measured, daily total time spent on the daily routine activities of said service user and the comparable ideal duration spent on said activities by one generally accepted to be leading a balanced lifestyle.

18. The system as recited in claim 12, wherein said configuration of said balance displacement factor algorithm further adapted so as to be a function of the difference between the measured, daily total time spent on the daily routine activities of said service user and the comparable ideal duration spent on said activities by one generally accepted to be leading a balanced lifestyle.

19. The system as recited in claim 11, wherein said configuration of said stress indicator percentage algorithm further adapted so as to be a function of the duration and quality of the sleep of said service user and the level of effort devoted to and the resulting productivity of the work of said service user.

20. The system as recited in claim 12, wherein said configuration of said stress indicator percentage algorithm further adapted so as to be a function of the duration and quality of the sleep of said service user and the level of effort devoted to and the resulting productivity of the work of said service user.
